(19) United States
(12) Patent Application Publication
(10) Pub. No.: US 2025/0382184 A1
(43) Pub. Date: Dec. 18, 2025

(54) A Negative Electrode Active Material and a Preparation Method thereof

(71) Applicant: SHANGHAI SHANSHAN TECH CO., LTD., Shanghai (CN)

(72) Inventors: Fei Ma, Shanghai (CN); Liangqin Wei, Shanghai (CN); Yuhu Wu, Shanghai (CN); Fengfeng Li, Shanghai (CN)

(21) Appl. No.: 18/723,108

(22) PCT Filed: Dec. 23, 2021
(86) PCT No.: PCT/CN2021/140824

§ 371 Date: May 2, 2025

(51) Int. Cl. C01B 33/029; C01B 33/03; C01B 33/20; H01M 10/0525

(52) U.S. Cl. CPC C01B 33/029; C01B 33/03; C01B 33/20; H01M 10/0525

(57) ABSTRACT

The application provides a negative electrode active material and a preparation method thereof, wherein the negative electrode active material comprises: porous core, comprising a base material and a boron-containing substance dispersed in the base material, wherein the base material comprises silicon and MSiO₃, where M represents metal; pores of the porous core are filled with a silicon compound, and the silicon compound does not fully fill the pore. The negative electrode active material and the preparation method thereof have good material stability while ensuring high gram capacity and initial charge-discharge efficiency, and the lithium-ion battery made of it as a negative electrode has excellent fast charge and cycle characteristics, and may also reduce the expansion of the battery during the cycle.

### TECHNICAL FIELD

The disclosure relates to the field of lithium ion batteries, in particular to a negative electrode active material and a preparation method thereof.

### BACKGROUND

With the development of modern electronic products such as smart phones, wearable devices and new energy vehicles, the requirements for energy density, safety and cost of the core power module-battery pack are getting higher and higher, and the market urgently calls for innovation of material systems. Silicon-based materials have significant advantages in energy density. However, the proportion that may achieve scale and successfully introduce use on the consumer end of batteries is still very low.

The negative electrode expansion of pure silicon system is too large and the cycle times are generally low. The silicon oxide material has a buffer structure between silicon atoms, which greatly enhances the structural stability. Therefore, the silicon oxide material has a significant performance improvement in the limit problems such as cycle life and expansion, which limit the application of silicon materials, but the low first coulomb efficiency is an important factor limiting its promotion.

In order to improve the comprehensive performance of the negative electrode port, the market has put forward the requirements of “three high” silicon based negative electrode materials with high initial charge-discharge efficiency, high capacity and high cycle stability. However, the current common solution has problems such as low capacity (<1600 mAh/g), low efficiency (<85%), poor cycle stability or these three performance are not balance, which hinders its prospects for large-scale application.

### BRIEF SUMMARY

The technical problem to be solved by the disclosure is to provide a negative electrode active material and the preparation method thereof, which has very good material stability while ensuring high gram capacity and initial charge-discharge efficiency, and the lithium-ion battery made of it as a negative electrode has excellent fast charge and cycle characteristics, and may also reduce the expansion of the battery during the cycle.

According to some aspects of the present disclosure, a preparation method for a negative electrode active material is provided. The preparation method for a negative electrode active material including: providing a first mixture comprising silicon, silicon dioxide, a metal and/or a metal oxide, and a boron-containing substance, or providing a second mixture comprising silicon oxide, a metal and/or a metal oxide, and a boron-containing substance; components of the first mixture or the second mixture are chemically reacted and vaporized to form a gas mixture, and the gas mixture comprises MSiO₃, where M represents the metal; the gas mixture is condensed and pulverized to obtain a porous core, and the porous core comprises a base material and a boron-containing substance dispersed in the base material, wherein the base material comprises silicon and MSiO₃, where M represents the metal; and the pores of the porous core are filled, comprising: silane and/or a silane derivative are adsorbed in the pores of the porous core by intermolecular force and thermal decomposition to form elemental-form silicon and gas, where the elemental-form silicon reacts with the porous core and forms a silicon compound in the pores.

In some embodiments of the present application, the ratio of the pore volume after the pore filling to the pore volume before the pore filling is 0.0001˜0.1, and the ratio of the specific surface area of the porous core after the pore filling to the specific surface area before the pore filling is 0.005˜0.2, and the ratio of the silicon mass of the porous core after the pore filling to the silicon mass before the pore filling is 1˜1.45.

In some embodiments of the present application, before the pores of the porous core are filled, the median particle size of the porous core is 1 μm˜10 μm, and the specific surface area of the porous core is 30 m²/g˜1000 m²/g, the pore volume is 0.05 cm³/g˜0.5 cm³/g, and the pore size is 0.2 nm˜500 nm, the pore volume of 0.2 nm˜100 nm is equal to or higher than 90%; after the pores of the porous core are filled, the specific surface area of the porous core is 2 m²/g˜10 m²/g, the pore volume is 0.001 cm³/g˜0.045 cm³/g, the pore size is 1 nm˜40 nm, and the size of silicon grain is equal to or lower than 10 nm.

In some embodiments of the present application, the silane derivative comprises at least one of SiHCl₃, SiH₂Cl, SiH₃Cl, SiHBr₃ and SiH₂Br.

In some embodiments of the present application, the temperature when the pores of the porous core are filled is from 400° C. to 850° C., and the gas flow rate of the silane and/or silane derivative is from 1 L/min to 50 L/min.

In some embodiments of the present application, in the negative electrode active material, the mass of the elemental-form silicon decreases gradiently from the surface of the porous core to the center, and 2.8≥mₑ/m_{c}≥1, where m_{c} is the mass of the elemental-form silicon in the center of the porous core, and mₑ is the mass of the elemental-form silicon in the surface of the porous core.

In some embodiments of the present application, the temperature when components of the first mixture or the second mixture are chemically reacted and vaporized is 1000° C.˜1450° C., the temperature when the gas mixture is condensed is 400° C.˜900° C., and the temperature difference between vaporization and condensation is equal to or higher than 300° C.

In some embodiments of the present application, before the pores of the porous core are filled, the mass of the silicon is equal to or higher than 40% of the total mass of the porous core, the mass of the metal is equal to or lower than 12% of the total mass of the porous core, and the mass of the boron is equal to or lower than 2.5% of the total mass of the porous core.

In some embodiments of the present application, the molecular formula of the silicon oxide is SiOx, 0.7<x<1.5; the metal comprises at least one of Mg, Ca, Sr, Ba and Li; the boron-containing substance comprises boron and/or boron oxide.

In some embodiments of the present application, after the pores of the porous core are filled, the preparation method further comprises: forming a carbon material layer on the surface of the porous core by chemical vapor deposition, and the gas of the chemical vapor deposition comprises at least one of methane, melamine, aniline, ethylene, acetylene, propane, propyl and methanol, the temperature of the gas is 800° C.˜1100° C.

In some embodiments of the present application, the thickness of the carbon material layer is equal to or lower than 40 nm, and the mass of the carbon element is from 0.5% to 10% of the total mass of the negative electrode active material.

According to some aspects of the present disclosure, a negative electrode active material is provided. The negative electrode active material includes: porous core, comprising a base material and a boron-containing substance dispersed in the base material, wherein the base material comprises silicon and MSiO₃, where M represents metal; pores of the porous core are filled with a silicon compound, and the silicon compound does not fully fill the pore.

In some embodiments of the present application, the mass of the silicon decreases gradiently from the surface of the porous core to the center, and 2.8≥mₑ/m_{c}≥1, where m_{c} is the mass of the elemental-form silicon in the center of the porous core, and mₑ is the mass of the elemental-form silicon in the surface of the porous core.

In some embodiments of the present application, the mass of the silicon is equal to or higher than 40% of the total mass of the porous core, the mass of the metal is equal to or lower than 12% of the total mass of the porous core, and the mass of the boron is equal to or lower than 2.5% of the total mass of the porous core.

In some embodiments of the present application, the negative electrode active material further comprises a carbon material layer located on the surface of the porous core, and the thickness of the carbon material layer is equal to or lower than 40 nm, and the mass of the carbon element is from 0.5% to 10% of the total mass of the negative electrode active material.

In some embodiments of the present application, the metal comprises at least one of Mg, Ca, Sr, Ba and Li; the boron-containing substance comprises boron and/or boron oxide, the silicon compound comprises MSiO₃ or M₂SiO4.

Compared with the prior art, the negative electrode active material and the preparation method thereof in the applied technical scheme have the following beneficial effects:
the porous core is formed by vaporization-condensation method, and the metal are introduced in the preparation process, in particular, the metal, such as at least one of Mg, Ca, Sr, Ba and Li, may cause atomic rearrangement and chemical reaction to form a compound with structural formula MSiO₃, which may accumulate to form a gap after condensation, and then form a porous core. This method of pore formation does not require the use of organic compounds or template self-assembly, which is not only more environmentally friendly, but also makes the distribution of the metal more uniform by evaporation before condensation, and has better cycle stability when making batteries.

Silicon compounds are used to fill the pores of the porous core, which improves the gram capacity and the first coulomb efficiency, while maintaining high interface stability and capacity retention rate during the cycle of the lithium-ion battery.

The introduction of boron in the preparation process is conducive to improving the stability of the negative electrode material particles after the expansion of silicon particles, thus improving the cycle characteristics of the battery. At the same time, the method of evaporation before condensation also makes the boron evenly dispersed in the porous core.

### BRIEF DESCRIPTION OF THE DRAWINGS

The following drawings describe the exemplary embodiment disclosed in this application in detail. The same reference numerals indicate similar structures in several views of the drawings. Those skilled in the art may understand that these embodiments are non-limiting and exemplary embodiments. The drawings are only for the purpose of illustration and description, and are not intended to limit the scope of this application. Other embodiments may also fulfill the inventive intent of this application. It should be understood that the drawings are not drawn to scale.

FIG. 1 is the flow diagram of the preparation method of the negative electrode active material for the embodiment of this application;

FIG. 2 shows the silicon content distribution diagram of the cross section of the porous core in the embodiment of this application.

FIG. 3 shows the porous core before the pore filling in Embodiment 12 of this application and the pore volume distribution diagram of the negative electrode active material in Embodiment 12, Embodiment 26, and Comparative 1 and Comparative 2.

FIG. 4 shows the pore volume distribution of the negative electrode active material in Embodiment 5 and Embodiment 12 and the porous core before the pore filling of Embodiment 5 and Embodiment 12 of this application;

FIG. 5 shows the resorption and desorption curves of porous core before and after the pore filling in Embodiment 5 and Embodiment 12 of this application.

FIG. 6 shows the content of silicon negative electrode material required for mixing the silicon negative electrode material of Embodiment 5, Embodiment 12, Embodiment 16, Comparative 1 and Comparative 2 with the artificial graphite material to a 500 g capacity negative electrode, and the corresponding first coulomb efficiency of each.

### DETAILED DESCRIPTION

The following description provides the specific disclosure scenarios and requirements of this disclosure in order to enable those skilled in the art to make or use the contents of this disclosure. Various modifications to the disclosed embodiment will be apparent to those skilled in the art, and the general principles defined herein may be applied to other embodiment and without departing from the scope of this disclosure. Therefore, this disclosure is not limited to the illustrated embodiment, but is to be accorded the widest scope consistent with the claims.

After a lot of research, the inventor found that the design and selection of the negative electrode active material core has an important impact on the performance of the battery. If the selected core has a low capacity (<400 mAh/g, such as Carbon), in order to obtain a negative electrode material with a gram capacity of more than 2000 mAh/g, a mass fraction of about 50% of silicon need to be deposited. However, the silicon may expand and contract rapidly during the battery cycle, thus the deposited silicon becomes an important deterioration factor in the subsequent battery cycle. The gram capacity of the porous core prepared by the applied technical solution may exceed 1200 mAh/g. Therefore, the gram capacity is able to reach 2000 mAh/g by only depositing the mass fraction of 10%˜20% of the silicon, while the special pore distribution makes the silicon after the pore filling has a good particle and high cycle stability.

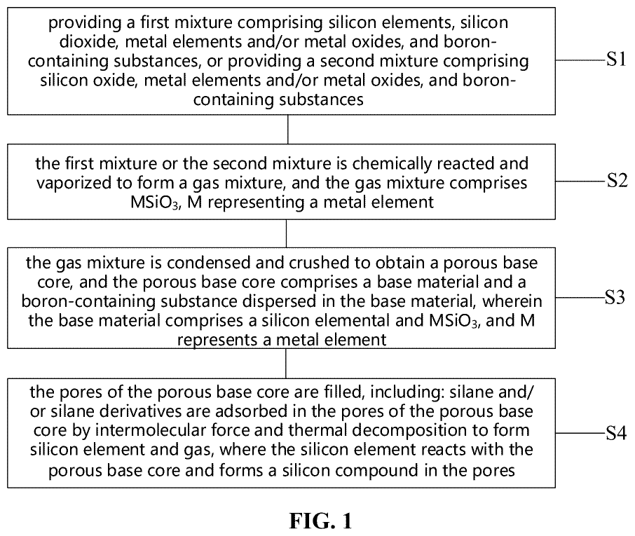

Referring to FIG. 1, the embodiment of the present application provides a preparation method for a negative electrode active material. The preparation method for a negative electrode active material including:
Step 1: providing a first mixture comprising silicon, silicon dioxide, a metal and/or a metal oxide, and a boron-containing substance, or providing a second mixture comprising silicon oxide, a metal and/or a metal oxide, and a boron-containing substance;
Step 2: components of the first mixture or the second mixture are chemically reacted and vaporized to form a gas mixture, and the gas mixture comprises MSiO₃, where M represents the metal;
Step 3: the gas mixture is condensed and pulverized to obtain a porous core, and the porous core comprises a base material and a boron-containing substance dispersed in the base material, wherein the base material comprises silicon and MSiO₃, where M represents the metal; and
Step 4: the pores of the porous core are filled, comprising: silane and/or a silane derivative are adsorbed in the pores of the porous core by intermolecular force and thermal decomposition to form elemental-form silicon and gas, where the elemental-form silicon reacts with the porous core and forms a silicon compound in the pores.

When preparing the porous core of the negative electrode active material, a first mixture or a second mixture may be used as the initial material, in which both the metal and the metal oxide may be added simultaneously, or only one of the metal and the metal oxide is selected. The metal and/or the metal oxide may cause the first mixture or the second mixture to undergo atomic rearrangement during the reaction. A new form of atomic stack is formed, which in turn makes the final product porous. The selection of the metal and the metal oxide is also essential for the improvement of the performance of the negative electrode active material. Both the metal and the metal elements in the metal oxide are easy to react with SiO₂ to form a silicate skeleton component with a zeolite structure and the pore size distribution should be suitable for filling holes. At the same time, the metal and the metal oxide can not react with the silicon. Therefore, the silicon may be dispersed on the surface of the metal and the metal oxide, the porous core may have a gram capacity of more than 1200 mAh/g. In embodiment of this application, both the metal and the metal element of the metal oxide may include at least one of Mg, Ca, Sr, Ba, and Li. For example, the metal may include at least one of the Mg, Ca, Sr and Ba, and the metal oxide may include at least one of the MgO, CaO, BaO, SrO and Li₂O.

The boron-containing substance may include at least one of boron and boron oxide. The boron-containing substance makes the porous core includes the boron, the boron may improve the expansion of silicon particles, improve the particle stability of the negative electrode material, and thus improve the cycle characteristics of the battery. The molecular formula of the silicon oxide is SiOx, and the value of x may also affect the performance of the negative electrode material. If the value of x is too high, it may lead to too much oxide composition, and the gram capacity of the negative electrode material is low; if the value of x is too low, it may lead to high mass fraction of silicon in the negative electrode material, which makes the volume expansion of the negative electrode material large, resulting in poor cycle performance of the battery. In embodiment of this application, 0.7<x<1.5.

In the first mixture or the second mixture, the mass percentage of the silicon (also referred to as the “silicon content”) is equal to or higher than 40%, the mass percentage of the metal (also referred to as the “metal content”) is equal to or lower than 12%, and the mass percentage of the boron-containing element (also referred to as the “boron content”) is equal to or lower than 2.5%. The mass percentage of the silicon, the metal, and the boron need to match with each other in order to achieve the best performance of the negative electrode active material. In particular, if the silicon content is too low, the gram capacity of the porous core may be low. When the metal content is too low, the specific surface area of the porous core may be low, and the ideal hole filling effect may not be obtained, and the gram capacity of the negative electrode active material may be low. When the metal content is too large, it may lead to too much silicate content, and the porous core impedance may increase, thus affecting the battery cycle and safety performance. When the boron content is too high, it may lead to excessive borooxygen compounds, which is easy to enrich, resulting in an increase in the porous core impedance, affecting the cycle and safety of the battery.

The temperature is raised to cause the first mixture or the second mixture to undergo a chemical reaction and evaporation, such as the first mixture or the second mixture at an ambient temperature of 1000° C.˜1450° C., and the vacuum degree of the environment can be 10⁻³ Pa˜10² Pa. When the first mixture is used as a raw material, the chemical reaction that occurs mainly consists of reaction one and/or reaction two, and the reaction one and reaction two may be carried out simultaneously:
Reaction 1: the reaction of silicon, silicon oxide and the metal produces MSiO₃ and new generated silicon, where M represents the metal;
Reaction 2: the reaction of silicon, silicon oxide and metal oxide produces MSiO₃ and new generated silicon, where M represents the metal.

When the second mixture is used as the raw material, the chemical reaction that occurs mainly includes the following reaction 3 and/or reaction 4, and the reaction 3 and reaction 4 may be carried out synchronously:
Reaction 3: The reaction of silicon oxide and the metal produces MSiO₃ and new generated silicon, where M represents the metal;
Reaction four: The reaction of silicon oxide and metal oxide produces MSiO₃ and the new generated silicon, where M represents the metal.

Whether the first mixture is used as the raw material or the second mixture is used as the raw material, the resulting gas mixture includes MSiO₃. MSiO₃ formed by atomic rearrangement has a new atomic stacking mode, and this phase itself includes a certain zeolite-like pore structure, which also determines that the final the porous core has a pore structure.

The gas mixture is then condensed to form a solid mixture, and the solid mixture is pulverized to obtain a porous core. The temperature of the condensation may be 400° C.˜900° C., and the temperature difference between evaporation and condensation is equal to or higher than 300° C., thus the gas mixture may be cured completely. At the same time, the temperature of evaporation and condensation and the temperature difference between the evaporation and condensation also affects the evaporation rate and condensation rate, and then affect the pore size and pore volume of the porous core. It directly determines the effect of filling holes and the effect of gram capacity improvement. It is found that the most obvious impact of the temperature and the temperature difference between evaporation and condensation is that the specific surface area of the porous core may fluctuate sharply, thus the stability and change of the specific surface area parameter may be used as one of the key monitoring factors of the process effect.

The embodiment of this application adopt the gas-phase condensation method to form porous core without the use of organic compounds or templates to self-assemble into pores, which is not only more friendly to the environment, but also the X-ray energy spectrum detection shows that the metal and boron are dispersed, without significant agglomeration or concentration enrichment area, thus the distribution of the metal and boron in the porous core is very uniform. It has better cycle stability when it is made into batteries.

The porous core includes a base material and a boron-containing substance dispersed in the base material, wherein the base material includes silicon and MSiO₃, and M represents the metal. The median particle size of the porous core is 1 μm˜10 μm, and the specific surface area of the porous core is 30 m²/g˜1000 m²/g, the pore volume is 0.05 cm³/g˜0.5 cm³/g, and the pore size is 0.2 nm˜500 nm, the pore volume of 0.2 nm˜100 nm is equal to or higher than 90%. In the porous core, the mass of the silicon is equal to or higher than 40% of the total mass of the porous core, the mass of the metal is equal to or lower than 12% of the total mass of the porous core, and the mass of the boron is equal to or lower than 2% of the total mass of the porous core.

The embodiment of the present application also uses a silicon-containing gas source to fill the pores of the porous core, thereby reducing the pore volume and increasing the silicon content. The filling method may include: in a dynamic heating furnace or a dynamic rotary furnace or a fluidized reactor, a silicon-containing gas source is used as a filling reagent to carry out gas-solid mixing reaction, and a filling material is formed in the pore after thermal adsorption, thermal decomposition and chemical reaction of the silicon-containing gas source. The silicon-containing gas source may include silane and/or silane derivative, where the silane derivative includes, for example, at least one of SiHCl₃, SiH₂Cl, SiH₃Cl, SiHBr₃ and SiH₂Br. The silane or the silane derivative may be adsorbed in the pore of the porous core by intermolecular force, and thermal decomposition at a certain temperature to form a elemental-form silicon and gas, wherein the elemental-form silicon reacts with the porous core and forms a silicon compound in the pore. For example, the thermal decomposition equation includes: SiH₄→Si+2H₂, SiHCl₃→Si+HCl+Cl₂, etc. The temperature, time and the flow rate of silicon source gas may affect the pore volume and specific surface area, which need to be controlled reasonably. In some embodiments, the temperature when the pore is filled is 400° C. to 850° C., and the gas flow rate of the silane and/or silane derivative is 1 L/min to 50 L/min.

The ratio of the pore volume after the pore filling to the pore volume before the pore filling is 0.0001˜0.1, and the ratio of the specific surface area of the porous core after the pore filling to the specific surface area before the pore filling is 0.005˜0.1, and the ratio of the silicon mass of the porous core after the pore filling to the silicon mass before the pore filling is 1.02˜1.45. In some embodiments, the specific surface area of the porous core after pore filling is 2 m²/g˜10 m²/g, the pore volume is 0.001 cm³/g˜0.045 cm³/g, and the pore size is 1 nm˜40 nm. At the same time of reducing the pore volume, silicon deposited material was formed inside the pore, and the silicon grain of the material obtained by X-ray diffraction analysis did not exceed 10 nm.

Since the porous core of the embodiment of this application includes the silicon before the hole filling, the gram capacity of the porous core before the hole filling has exceeded 1200 mAh/g, and the gram capacity of the obtained negative electrode active material may be increased to 2000 mAh/g if the silicon with a mass fraction of about 24% (as a percentage of the total mass of the negative electrode active material) is deposited in the pore. For a porous core structure with the same pore volume but does not contain the silicon, in order to increase the gram capacity of the negative electrode active material to 2000 mAh/g, it is necessary to deposit 70% silicon in the pore. Therefore, the preparation method of the present application embodiment may obtain a higher gram capacity by using a lower hole filling amount. And because the amount of filling holes is greatly reduced, the temperature of filling holes may be reduced correspondingly, and the time of filling holes may be appropriately shortened, reducing the energy consumption.

After the pore filling, the silicon mass decreases gradiently from the surface of the porous core to the center, and 2.8≥mₑ/m_{c}≥1, where m_{c} is the silicon mass of the center of the porous core, and mₑ is the silicon mass of the surface of the porous core. The gradient reduction means that the mass proportion on the circumferential plane at the same distance from the center of the porous core is the same or substantially the same, and the mass of the silicon decreases step by step as the distance from the center of the porous core decreases. The gradient distribution of the silicon is realized by the design of pore reservation in the porous core and the control of pore filling parameters.

The mass of silicon is reduced in a gradient from the surface of the porous core to the center, which may make the active silicon component expand and contract in the process of charging and discharging of the battery. Under the premise of the same silicon content, the expansion and contraction degree of the particles may gradually decrease from the edge of the negative electrode active material to the core, thus the negative electrode active material is not easy to break as a whole, thus extend battery cycle life.

After the pore filling, the preparation method further includes: surface modification of the porous core after the pore filling by gas phase method in a continuous dynamic furnace. A layer of carbon material is formed on the surface of the porous core by chemical vapor deposition, and the gases of the chemical vapor deposition include at least one of methane, melamine, aniline, ethylene, acetylene, propane, propyl and methanol, and the gas temperature is 800° C.˜1100° C. The thickness of the carbon material layer is equal to or lower than 40 nm, and the mass of the carbon element is from 0.5% to 10% of the total mass of the negative electrode active material.

In summary, by adopting the preparation method of the embodiment of the present application, a negative electrode material for lithium ion battery may be obtained with both high gram capacity (up to 2000 mAh/g) and high first coulomb efficiency (up to 90%). At the same time, the obtained material maintains a high capacity retention rate and high storage life during the lithium-ion battery cycle, and is expected to become a solution for high-capacity negative electrode materials.

The present application embodiment also provides a negative electrode active material including: a porous core, comprising a base material and a boron-containing substance dispersed in the base material, wherein the base material comprises silicon and MSiO₃, where M represents metal; pores of the porous core are filled with a silicon compound, and the silicon compound does not fully fill the pore.

In some embodiments, the specific surface area of the negative electrode active material is 2 m²/g˜10 m²/g, the pore volume is 0.001 cm³/g˜0.045 cm³/g, the pore size is 1 nm˜40 nm, and the size of the silicon grain does not exceed 10 nm.

In some embodiments, in the negative electrode active material, the silicon mass decreases gradiently from the surface of the porous core to the center, and 2.8≥mₑ/m_{c}≥1, where m_{c} is the silicon mass at the center of the porous core and mₑ is the silicon mass at the surface of the porous core. In the porous core, the mass of the silicon is equal to or higher than 50% of the total mass of the porous core, the mass of the metal is equal to or lower than 12% of the total mass of the porous core, and the mass of the boron is equal to or lower than 2.5% of the total mass of the porous core.

In some embodiments, the negative electrode active material also includes a layer of carbon material located on the surface of the porous core, and the thickness of the carbon material layer does not exceed 40 nm, and the mass of the carbon element is 0.5% to 10% of the total mass of the negative electrode active material.

In some embodiments, the metal include at least one of Mg, Ca, Sr, Ba, or Li, the boron-containing substances include boron and/or boron oxide, and the silicon compounds include MSiO₃ or M₂SiO₄.

The negative electrode active material of the embodiment of this application increases the gram capacity to more than 2000 mAh/g by filling the pores of the porous core with silicon compounds. The base material includes MSiO₃, therefore, the porous core has an ideal distribution of pores, thus the silicon after filling the holes has smaller particles and higher cycle stability. At the same time, boron-containing substances are dispersed in the base material, which is conducive to improving the stability of the negative electrode material particles after the expansion of silicon particles, so as to improve the cycle characteristics of the battery.

### Embodiment 1

A preparation method for a negative electrode active material includes: providing a first mixture including silicon, silicon dioxide, magnesium element and boron oxide, wherein the mass of magnesium element is 10% of the total mass of the first mixture, and the mass of boron is 0.5% of the total mass of the first mixture;

The first mixture is chemically reacted and vaporized to form a gas mixture, and the gas mixture includes MgSiO₃; the gas mixture is condensed and pulverized to obtain a porous core, wherein the specific surface area of the porous core is 123 m²/g, the pore volume is 0.23 cm³/g, the silicon content (the mass percentage of silicon in the porous core) is 56%, the proportion of micropores (<2 nm) is 2%, and the proportion of mesoporous pores (2 nm˜50 nm) is 63%. The proportion of large pores (50 nm˜100 nm) was 27%, and the proportion of pore size of 0.2 nm˜100 nm was 92%;

At 450° C., SiH₄ is adsorbed in the pore of the porous core by intermolecular force and thermal decomposition to form silicon and hydrogen, wherein the silicon reacts with the porous base nuclear and forms a silicon compound in the pore, and the ratio of the specific surface area after the pore filling to the specific surface area before the pore filling is 0.142. The ratio of silicon content after hole filling to silicon content before hole filling is 1.02. FIG. 2 shows the silicon content distribution diagram of the cross section of the porous core in the embodiment of this application. The diagram shows the distribution diagram of silicon. The darker the color, the higher the silicon content, the lighter the color, the lower the silicon content.

Finally, a carbon material layer is formed on the surface of the porous core by chemical vapor deposition, and the carbon material layer only includes carbon element, the mass of carbon element is 4.5% of the total mass of the negative electrode active material.

### Embodiment 2˜30

The detailed process description is referred to Embodiment 1, and the process parameters are shown in Table 1.

### Comparative 1

Compared with Embodiment 1, hole filling is not carried out, other process descriptions are referred to Embodiment 1, and specific process parameters are shown in Table 1.

### Comparative 2

Compared with Embodiment 1, the porous core is not doped with metal, other process descriptions are referred to Embodiment 1. The specific process parameters are shown in Table 1.

### Comparative 3

The pyrolytic carbon of phenolic resin was used as the base, and then silane was deposited to a specific surface area of 8 m²/g and silicon content of 52%. Other process parameters are shown in Table 1.

The negative electrode active materials obtained in embodiments 1˜30 and Comparative 1˜3 are tested as follows:

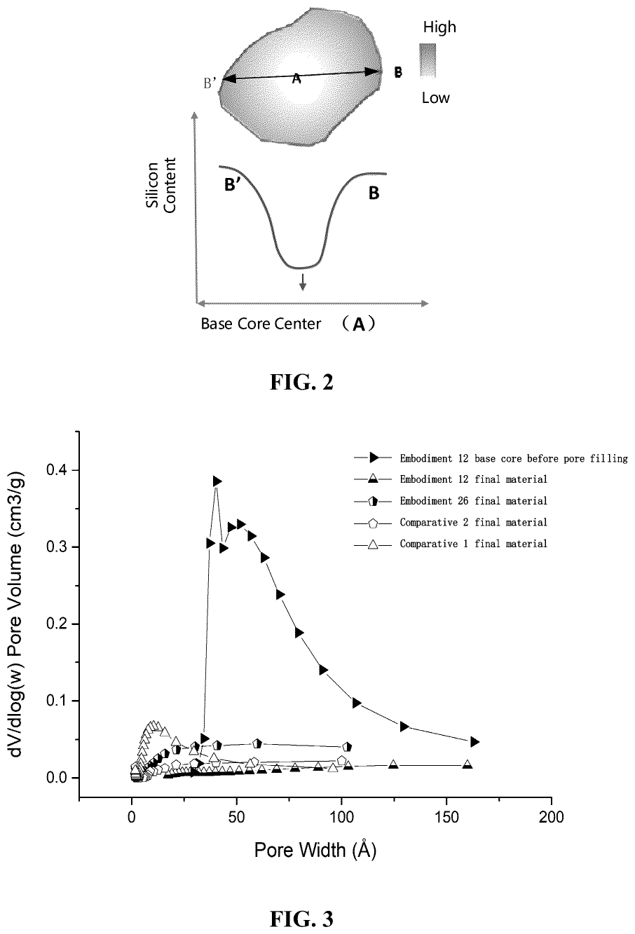

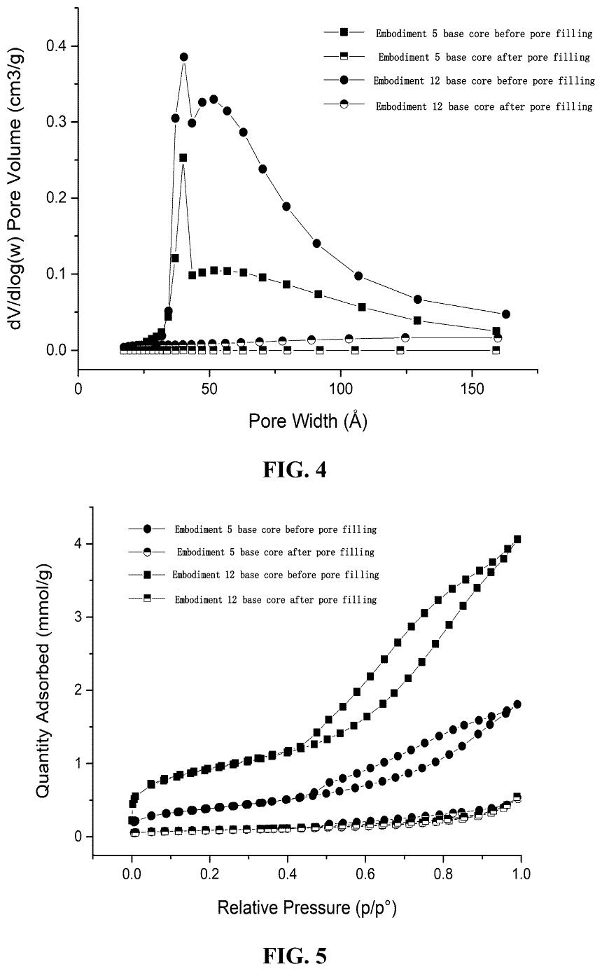

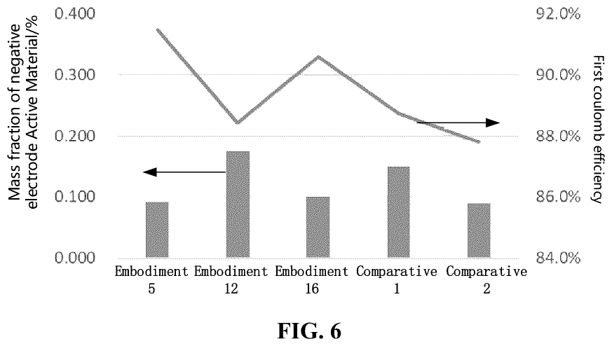

(1) The pore diameter of each embodiment and comparative is tested by using Mack Instruments ASAP2020 as test equipment. The test method is as follows: Software version V3.04H; the adsorption medium is N₂; Vacuum degassing pretreatment temperature: 150 degrees; pretreatment time: 1 hour; Sample weight: 0.3±0.05 g; Using the BJH model, Faas modification was selected, Halsey: t=3.54*[−5/ln(P/P°)]^{\hat{ }0.333}; Aperture range: 0.1 nm to 300.0000 nm; Adsorbent property factor: 0.95300 nm; Density conversion factor: 0.0015468; Opening rate at both ends: 0.00; According to the aperture distribution range obtained by the desorption of the BJH model, the average pore diameter is automatically calculated and the results are shown in Table 1. According to the dV/d log(w) Pore Volume of desorption by BJH model, the porous core before the pore filling in Embodiment 12 of this application and the pore volume distribution diagram of the negative electrode active material in Embodiment 12, Embodiment 26, and Comparative 1 and Comparative 2 shown in FIG. 3 is obtained. FIG. 4 shows the pore volume distribution of the negative electrode active material in Embodiment 5 and Embodiment 12 and the porous core before the pore filling of Embodiment 5 and Embodiment 12 of this application. FIG. 5 shows the resorption and desorption curves of porous core before and after the pore filling in Embodiment 5 and Embodiment 12 of this application.

(2) The negative electrode active material of Embodiment 1˜26 and Comparative 1˜3, PAA (polyacrylic acid binder) and SP (conductive carbon black) were mixed with a mass ratio of 80:10:10, and 1 mol/L LiPF₆ as the electrolyte were applied to the battery system (Model CR2430), and the following electro-chemical performance tests were carried out at 25° C.:

The first delithium capacity and Coulomb efficiency test: discharge 10 mV at constant current 0.1C, stand for 10 minutes, and then continue to discharge at constant current 0.02C to 5 mV; Stand for 10 minutes, and then charge at 0.1C constant current to 1.5V. Test results are shown in Table 1.

60° C. for seven days Cap. vs. Initial test: discharge 10 mV at constant current 0.1C, stand for 10 minutes, and then continue to discharge at constant current 0.02C to 5 mV; stand for 10 minutes, then charge at 0.1C constant current to 1.5V; Discharge 10 mV at constant current 0.1C, stand for 10 minutes, and then continue to discharge at constant current 0.02C to 5 mV; stand for 10 minutes; Transfer the above batteries to a constant temperature oven at 60° C., and after shelving for 7 days, transfer them to a charge and discharge test cabinet, and then charge them to 1.5V at a constant current of 0.1C. The ratio of the capacity to the charging capacity in the first week before shelving is taken as a statistical item. The test results are shown in Table 1.

Cyclic performance test: Discharge 10 mV at constant current 0.1C, stand for 10 minutes, and then continue to discharge at constant current 0.02C to 5 mV; stand for 10 minutes, and then charge at 0.1C constant current to 1.5V, and then carry out the subsequent cycle. The test results are shown in Table 1.

The gram capacity and first coulomb efficiency of the negative electrode active material are different due to different pore filling, doping and surface coating schemes. Taking a typical artificial graphite material with a first delithium capacity of 350 mAh/g and a first coulomb efficiency of 94% as an example, the negative electrode active material of Embodiment 5, Embodiment 12, Embodiment 16, Comparative 1 and Comparative 2 are mixed with the artificial graphite material to form a negative electrode with a gram capacity of 500 mAh/g, respectively. The mass percentage of negative electrode active material required and the corresponding first coulomb efficiency are shown in FIG. 6. Comparing the Comparative 1 and Comparative 2, by using silicon compounds to fill the porous core, the embodiment of this application may obtain higher capacity and coulomb efficiency with less silicon addition, thus achieving the best overall cell performance.

TABLE 1
Process parameters and test results of Embodiments and Comparatives

| | | | | | | Base | | | | | | |
|---|---|---|---|---|---|---|---|---|---|---|---|---|
| | Base | | | | Base | core | Base | Base core pore | | | | |
| Item | core | M | M total | B | core | pore | core Si | distribution | | | | Pore fill |
| unit/ | Dv50 | species | content | content | scale | volume | content | micropore | Mesoporous | macropore | 0.2-100 | material |
| details | μm | / | % | % | m²/g | cm³/g | % | %( [symbol] 2 nm) | %(2 [symbol] | %(50 [symbol] | nm % | type |
| Embodiment1 | 5.0 | Mg | 10 | 0.5 | 123 | 0.23 | 56.0 | 2 | 63 | 27 | 92 | SiH [symbol] |
| Embodiment2 | 5.0 | Mg | 10 | 0.5 | 123 | 0.23 | 56.0 | 2 | 63 | 27 | 92 | SiH [symbol] |
| Embodiment3 | 5.0 | Mg | 10 | 0.5 | 123 | 0.23 | 56.0 | 2 | 63 | 27 | 92 | SiH [symbol] |
| Embodiment4 | 5.0 | Mg | 10 | 0.5 | 123 | 0.23 | 56.0 | 2 | 63 | 27 | 92 | SiH [symbol] |
| Embodiment5 | [symbol] .0 | Mg | 10 | 0.5 | 123 | 0.23 | 56.0 | 2 | 63 | 27 | 92 | SiH [symbol] |
| Embodiment6 | 5.0 | Mg | 10 | 0.5 | 123 | 0.23 | 56.0 | 2 | 63 | 27 | 92 | SiHCl |
| Embodiment7 | 5.0 | Mg | 10 | 0.5 | 123 | 0.23 | 56.0 | 2 | 63 | 27 | 92 | SiHCl |
| Embodiment8 | 5.0 | Mg | 10 | 0.5 | 123 | 0.23 | 56.0 | 2 | 63 | 27 | 92 | SiH [symbol] C |
| Embodiment9 | 5.0 | Mg | 10 | 0.8 | 129 | 0.24 | 55.7 | 5 | 69 | 22 | 96 | SiH [symbol] |
| Embodiment10 | 5.0 | Mg | 10 | 1.2 | 148 | 0.29 | 55.3 | 5 | 72 | 22 | 99 | SiH [symbol] |
| Embodiment11 | 5.0 | Mg | 10 | 1.7 | 160 | 0.41 | 54.8 | 5 | 78 | 15 | 98 | SiH [symbol] |
| Embodiment12 | 5.0 | Mg | 10 | 2.2 | 149 | 0.35 | 54.3 | 4 | 68 | 19 | 91 | SiH [symbol] |
| Embodiment13 | 5.0 | Mg | 10 | 0.5 | 123 | 0.23 | 56.0 | 2 | 63 | 27 | 92 | SiH [symbol] |
| Embodiment14 | 5.0 | Mg | 10 | 0.5 | 123 | 0.23 | 56.0 | 2 | 63 | 27 | 92 | SiH [symbol] |
| Embodiment15 | 5.0 | Mg | 10 | 0.5 | 123 | 0.23 | 56.0 | 2 | 63 | 27 | 92 | SiH [symbol] |
| Embodiment16 | 5.0 | Mg | 10 | 0.5 | 123 | 0.23 | 56.0 | 2 | 63 | 27 | 92 | SiH [symbol] |
| Embodiment17 | 5.0 | Mg | 10 | 0.5 | 123 | 0.23 | 5 [symbol] .0 | 2 | 63 | 27 | 92 | SiH [symbol] |
| Embodiment18 | 5.0 | Mg | 7 | 0.5 | 78 | 0.17 | 59.0 | 4 | 74 | 17 | 95 | SiH [symbol] |
| Embodiment19 | 5.0 | Mg | 5 | 0.5 | 59 | 0.09 | 61.0 | 5 | 76 | 10 | 91 | SiH [symbol] |
| Embodiment20 | 5.0 | Mg | 1 | 0.5 | 49 | 0.05 | 65.0 | 5 | 78 | 8 | 91 | SiH [symbol] |
| Embodiment21 | 2.9 | Mg | 10 | 0.5 | 156 | 0.35 | 55.0 | 2 | 67 | 29 | 98 | SiH [symbol] |
| Embodiment22 | 4.2 | Mg | 10 | 0.5 | 140 | 0.28 | 55.0 | 2 | 65 | 27 | 94 | SiH [symbol] |
| Embodiment23 | 6.5 | Mg | 10 | 0.5 | 102 | 0.18 | 56.0 | 3 | 62 | 25 | 90 | SiH [symbol] |
| Embodiment24 | 9.2 | Mg | 10 | 0.5 | 69 | 0.10 | 56.0 | 3 | 62 | 25 | 90 | SiH [symbol] |
| Embodiment25 | 5.0 | Mg + | 10 | 0.5 | 99 | 0.16 | 56.0 | 2 | 61 | 30 | 93 | SiH [symbol] |
| | | Li(Mg/ | | | | | | | | | | |
| | | Li = | | | | | | | | | | |
| | | 10:1) | | | | | | | | | | |
| Embodiment26 | 5.0 | Mg + | 10 | 0.5 | 74 | 0.11 | 56.0 | 2 | 61 | 30 | 95 | SiH [symbol] |
| | | Li(Mg/ | | | | | | | | | | |
| | | Li = | | | | | | | | | | |
| | | 10: [symbol] ) | | | | | | | | | | |
| Embodiment27 | 5.0 | Li | 10 | 0.5 | 5 | 0.01 | 56.0 | 3 | 62 | 25 | 90 | SiH [symbol] |
| Embodiment28 | 5.0 | Ca | 10 | 0.5 | 131 | 0.32 | 52.0 | 2 | 63 | 32 | 97 | SiH [symbol] |
| Embodiment29 | 5.0 | Sr | 10 | 0.5 | 78 | 0.10 | [symbol] 2.0 | 6 | 65 | 20 | 91 | SiH [symbol] |
| Embodiment30 | 7.0 | Ba | 10 | 0.5 | 54 | 0.06 | 47.3 | 5 | 69 | 18 | 92 | SiH [symbol] |
| Comparative1 | 5.0 | Mg | 10 | 0.5 | 123 | 0.23 | 56.0 | 2 | 63 | 27 | 92 | / |
| Comparative2 | 5.0 | / | 0 | 0.5 | 2.4 | 0.00 | 67.0 | 0 | 4 | 12 | 16 | SiH [symbol] |
| Comparative3 | 5.0 | / | 0 | 0 | 892 | 0.65 | 0.0 | 2 | 62 | 26 | 90 | SiH [symbol] |

| | | | | | | | | | 60 |
|---|---|---|---|---|---|---|---|---|---|
| | | | Base | | | | | | degree |
| | | | core scale | | | | | | for |
| | | | after hole | | | | | | seven |
| | | Si content | filling/ | | | | | Cycle | days |
| | | after hole | Base | | | First | | capacity | Cap. |
| | Pore fill | filling/ | core scale | Surface | | lithium | | vs. | vs |
| Item | material | Si content | before hole | coating | | removal | Coulomb | first | initial |
| unit/ | Temperature/ | before hole | filling | Carbon | Type and | capacity | efficiency | week | 90% |
| details | ° C. | / | / | content % | content of | mAh/g | % | 1.5 | SOC % |
| Embodiment1 | 450 | 1.02 | 0.142 | 4.5 | 0 | 1419 | 82.2 | 62.1 | 67.0 |
| Embodiment2 | 510 | 1.10 | 0.067 | 4.5 | 0 | 1621 | 83.5 | 65. [symbol] | 70.0 |
| Embodiment3 | 580 | 1.13 | 0.061 | 4.5 | 0 | 1723 | 84.3 | 7 [symbol] .4 | 73.0 |
| Embodiment4 | 620 | 1.18 | 0.053 | 4.5 | 0 | 1858 | 85.7 | 80.2 | 76.0 |
| Embodiment5 | 730 | 1.23 | 0.045 | 4.5 | 0 | 1993 | 87.3 | 80.5 | 81.0 |
| Embodiment6 | 530 | 1.07 | 0.072 | 4.5 | 0 | 1554 | 83.0 | 7 [symbol] .4 | 67.0 |
| Embodiment7 | [symbol] 0 | 1.11 | 0.067 | 4.5 | 0 | 1655 | 83.7 | 72.5 | 68.0 |
| Embodiment8 | 630 | 1.15 | 0.066 | 4.5 | 0 | 1756 | 84.7 | 77.5 | 62.0 |
| Embodiment9 | 630 | 1.16 | 0.063 | 4.5 | 0 | 1787 | 85.0 | 65.3 | 70.0 |
| Embodiment10 | 630 | 1.20 | 0.055 | 4.5 | 0 | 1907 | 86.3 | 72.5 | 71.0 |
| Embodiment11 | 630 | 1.30 | 0.051 | 4.5 | 0 | 2195 | 90.1 | 70.4 | 73.0 |
| Embodiment12 | 630 | 1.25 | 0.054 | 4.5 | 0 | 2062 | 88.3 | 70.2 | 78.0 |
| Embodiment13 | 590 | 1.18 | 0.053 | 4.5 | 0 | 1853 | 85.8 | 81.2 | 67.0 |
| Embodiment14 | 590 | 1.18 | 0.053 | 5.0 | 0 | 1842 | 85.7 | 83.2 | 64.0 |
| Embodiment15 | 590 | 1.18 | 0.053 | 5.6 | 0 | 1832 | 85.5 | 81.6 | 56.0 |
| Embodiment16 | 590 | 1.18 | 0.053 | 4.5 | N2/0.5 | 1832 | 85.3 | 84.5 | 68.0 |
| Embodiment17 | 590 | 1.18 | 0.053 | 4.5 | N2/1.0 | 1878 | 84.9 | 85.3 | 69.0 |
| Embodiment18 | 620 | 1.09 | 0.104 | 4.5 | 0 | 1593 | 83.3 | 64.5 | 77.0 |
| Embodiment19 | 620 | 1.02 | 0.137 | 4.5 | 0 | 1406 | 82.2 | 69.2 | 65.0 |
| Embodiment20 | 670 | 1.02 | 0.161 | 4.5 | 0 | 1400 | 82.2 | 71.2 | 60.0 |
| Embodiment21 | 580 | 1.24 | 0.048 | 4.5 | 0 | 2019 | 87.7 | 62.3 | 61.0 |
| Embodiment22 | 580 | 1.18 | 0.054 | 4.5 | 0 | 1852 | 85.7 | 72.3 | 64.0 |
| Embodiment23 | 580 | 1.09 | 0.074 | 4.5 | 0 | 1605 | 83.4 | 82.1 | 71.0 |
| Embodiment24 | 580 | 1.09 | 0.109 | 4.5 | 0 | 1602 | 83.3 | 65.4 | 75.0 |
| Embodiment25 | 500 | 1.08 | 0.076 | 4.5 | 0 | 1580 | 85.6 | 80.2 | 72.2 |
| Embodiment26 | 500 | 1.01 | 0.101 | 4.5 | 0 | 1550 | 85.3 | 75.4 | 73.2 |
| Embodiment27 | 500 | 0.50 | 1.500 | 4.5 | 0 | 1430 | 88.8 | 4 [symbol] .2 | 75.3 |
| Embodiment28 | 580 | 1.19 | 0.063 | 4.5 | 0 | 1 [symbol] 82 | 86.0 | 60.2 | 62.0 |
| Embodiment29 | 580 | 1.00 | 0.105 | 4.5 | 0 | 1343 | 82.0 | 58.2 | 61.0 |
| Embodiment30 | 580 | 1.04 | 0.190 | 5.0 | 0 | 1205 | 82.8 | 26.5 | 65.0 |
| Comparative1 | / | 1.00 | 1.000 | 4.5 | 0 | 1350 | 82.0 | 60.3 | 52.0 |
| Comparative2 | 580 | 1.15 | 1.000 | 4.5 | 0 | 2020 | 78.7 | 52.4 | 34.0 |
| Comparative3 | 580 | 1.52 | 0.010 | 4.5 | 0 | 2082 | 82.0 | 62.5 | 51.0 |

[symbol]

indicates data missing or illegible when filed

Finally, it should be understood that the example of the application disclosed herein is a description of the principle of the embodiment of the application. Other modified embodiments also fall within the scope of this application. Therefore, the embodiments disclosed in this application are only examples and not limitations. A person skilled in the art may implement the application in this application by adopting alternative configurations in accordance with the embodiments in this application. Therefore, embodiments of this application are not limited to those embodiments precisely described in the application.

1. A preparation method for a negative electrode active material, characterized in that, comprising:
providing a first mixture comprising silicon, silicon dioxide, a metal and/or a metal oxide, and a boron-containing substance, or providing a second mixture comprising silicon oxide, a metal and/or a metal oxide, and a boron-containing substance;
components of the first mixture or the second mixture are chemically reacted and vaporized to form a gas mixture, and the gas mixture comprises MSiO₃, where M represents the metal;
the gas mixture is condensed and pulverized to obtain a porous core, and the porous core comprises a base material and a boron-containing substance dispersed in the base material, wherein the base material comprises silicon and MSiO₃, where M represents the metal; and
the pores of the porous core are filled, comprising: silane and/or a silane derivative are adsorbed in the pores of the porous core by intermolecular force and thermal decomposition to form elemental-form silicon and gas, where the elemental-form silicon reacts with the porous core and forms a silicon compound in the pores.

2. The preparation method according to claim 1, characterized in that, the ratio of the pore volume after the pore filling to the pore volume before the pore filling is 0.0001˜0.1, and the ratio of the specific surface area of the porous core after the pore filling to the specific surface area before the pore filling is 0.005˜0.2, and the ratio of the silicon mass of the porous core after the pore filling to the silicon mass before the pore filling is 1˜1.45.

3. The preparation method according to claim 1, characterized in that, before the pores of the porous core are filled, the median particle size of the porous core is 1 μm˜10 μm, and the specific surface area of the porous core is 30 m²/g˜1000 m²/g, the pore volume is 0.05 cm³/g˜0.5 cm³/g, and the pore size is 0.2 nm˜500 nm, the pore volume of 0.2 nm˜100 nm is equal to or higher than 90%; after the pores of the porous core are filled, the specific surface area of the porous core is 2 m²/g˜10 m²/g, the pore volume is 0.001 cm³/g˜0.045 cm³/g, the pore size is 1 nm˜40 nm, and the size of silicon grain is equal to or lower than 10 nm.

4. The preparation method according to claim 1, characterized in that, the silane derivative comprises at least one of SiHCl₃, SiH₂Cl, SiH₃Cl, SiHBr₃ and SiH₂Br.

5. The preparation method according to claim 1, characterized in that, the temperature when the pores of the porous core are filled is from 400° C. to 850° C., and the gas flow rate of the silane and/or silane derivative is from 1 L/min to 50 L/min.

6. The preparation method according to claim 1, characterized in that, in the negative electrode active material, the mass of the elemental-form silicon decreases gradiently from the surface of the porous core to the center, and 2.8≥mₑ/m_{c}≥1, where m_{c} is the mass of the elemental-form silicon in the center of the porous core, and mₑ is the mass of the elemental-form silicon in the surface of the porous core.

7. The preparation method according to claim 1, characterized in that, the temperature when components of the first mixture or the second mixture are chemically reacted and vaporized is 1000° C.˜1450° C., the temperature when the gas mixture is condensed is 400° C.˜900° C., and the temperature difference between vaporization and condensation is equal to or higher than 300° C.

8. The preparation method according to claim 1, characterized in that, before the pores of the porous core are filled, the mass of the silicon is equal to or higher than 40% of the total mass of the porous core, the mass of the metal is equal to or lower than 12% of the total mass of the porous core, and the mass of the boron is equal to or lower than 2.5% of the total mass of the porous core.

9. The preparation method according to claim 1, characterized in that, the molecular formula of the silicon oxide is SiOx, 0.7<x<1.5; the metal comprises at least one of Mg, Ca, Sr, Ba and Li; the boron-containing substance comprises boron and/or boron oxide.

10. The preparation method according to claim 1, characterized in that, after the pores of the porous core are filled, the preparation method further comprises: forming a carbon material layer on the surface of the porous core by chemical vapor deposition, and the gas of the chemical vapor deposition comprises at least one of methane, melamine, aniline, ethylene, acetylene, propane, propyl and methanol, the temperature of the gas is 800° C.˜1100° C.

11. The preparation method according to claim 10, characterized in that, the thickness of the carbon material layer is equal to or lower than 40 nm, and the mass of the carbon element is from 0.5% to 10% of the total mass of the negative electrode active material.

12. A negative electrode active material, characterized in that, comprising:
a porous core, comprising a base material and a boron-containing substance dispersed in the base material, wherein the base material comprises silicon and MSiO₃, where M represents metal;
pores of the porous core are filled with a silicon compound, and the silicon compound does not fully fill the pore.

13. The negative electrode active material according to claim 12, characterized in that, the mass of the silicon decreases gradiently from the surface of the porous core to the center, and 2.8≥mₑ/m_{c}≥1, where m_{c} is the mass of the elemental-form silicon in the center of the porous core, and mₑ is the mass of the elemental-form silicon in the surface of the porous core.

14. The negative electrode active material according to claim 12, characterized in that, the mass of the silicon is equal to or higher than 40% of the total mass of the porous core, the mass of the metal is equal to or lower than 12% of the total mass of the porous core, and the mass of the boron is equal to or lower than 2.5% of the total mass of the porous core.

15. The negative electrode active material according to claim 12, characterized in that, the negative electrode active material further comprises a carbon material layer located on the surface of the porous core, and the thickness of the carbon material layer is equal to or lower than 40 nm, and the mass of the carbon element is from 0.5% to 10% of the total mass of the negative electrode active material.

16. The negative electrode active material according to claim 12, characterized in that, the metal comprises at least one of Mg, Ca, Sr, Ba and Li; the boron-containing substance comprises boron and/or boron oxide, the silicon compound comprises MSiO₃ or M₂SiO₄.
